(19) United States
(12) Patent Application Publication
(10) Pub. No.: US 2026/0142207 A1
(43) Pub. Date: May 21, 2026

(54) METHOD AND AN APPARATUS, A CONTROLLER, A SYSTEM, AND A PROGRAM PRODUCT FOR LIMITING CURRENT

(71) Applicant: Robert Bosch GmbH, Stuttgart (DE)

(72) Inventors: Wei Chen, Wuxi (CN); Bo Wei, Wuxi (CN)

(21) Appl. No.: 19/390,919

(22) Filed: Nov. 17, 2025

(30) Foreign Application Priority Data
Nov. 18, 2024 (CN) 2024 1165 1123.1

(51) Int. Cl. H01M 8/04858; H01M 8/04537

(52) U.S. Cl. CPC H01M 8/04902; H01M 8/04626

(57) ABSTRACT

A method and apparatus, a controller, a fuel cell system, and a program product for limiting current are disclosed. The method includes (i) determining the power of a hydrogen circulating pump in a fuel cell system, (ii) determining a current limiting adjustment parameter based on the power of the hydrogen circulating pump, wherein the current limiting adjustment parameter is inversely proportional to the power of the hydrogen circulating pump, and (iii) adjusting a current limiting value of a DC-DC converter in the fuel cell system according to the determined current limiting adjustment parameter, wherein the current limiting value is directly proportional to the current limiting adjustment parameter. The method uses the power of the hydrogen circulating pump to judge whether the fuel cell system is flooded, thereby adjusting the current limiting value of the DC-DC converter to maintain the normal operation of the fuel cell system when hydrogen is insufficient.

This application claims priority under 35 U.S.C. § 119 to application no. CN 2024 1165 1123.1, filed on Nov. 18, 2024 in China, the disclosure of which is incorporated herein by reference in its entirety.

Examples of the present disclosure relate generally to the field of fuel cell technology, and in particular to a method and an apparatus, a controller, a fuel cell system, and a program product for limiting current.

### BACKGROUND

Fuel cells have been widely used in many fields, such as in vehicles. Vehicles that apply fuel cells include fuel cell electric vehicles (FCEVs). Fuel cells typically exist in the form of fuel cell systems. Fuel cell systems are complex systems, and their core is a fuel cell stack (also referred to as “stack”) based on electrochemical reactions. In the stack, fuels such as hydrogen and oxygen from the air undergo an electrochemical reaction under the action of a catalyst to generate electrical energy, which serves as the main power source for FCEVs. The fuel cell system uses a hydrogen circulating pump (ARB, anode recirculation blower) to return hydrogen from the exhaust end of the fuel cell to the intake end, thus enabling the recycling of hydrogen.

### SUMMARY

Example of the present disclosure provide a method and an apparatus, a controller, a fuel cell system, a program product, and a machine-readable storage medium for limiting current.

According to a first aspect of the present disclosure, a method for limiting current is provided. The method comprises determining the power of a hydrogen circulating pump in a fuel cell system. The method further comprises determining a current limiting adjustment parameter based on the power of the hydrogen circulating pump. Wherein, the current limiting adjustment parameter is inversely proportional to the power of the hydrogen circulating pump. The method further comprises adjusting a current limiting value of a DC-DC converter in the fuel cell system according to the determined current limiting adjustment parameter. Wherein, the current limiting value is directly proportional to the current limiting adjustment parameter.

According to a second aspect of the present disclosure, an apparatus for limiting current is provided. The apparatus comprises: a first determination unit, a second determination unit, and an adjustment unit. The first determination unit is configured to determine the power of the hydrogen circulating pump in the fuel cell system. The second determination unit is configured to determine the current limiting adjustment parameter based on the power of the hydrogen circulating pump. Wherein, the current limiting adjustment parameter is inversely proportional to the power of the hydrogen circulating pump. The adjustment unit is configured to adjust a current limiting value of a DC-DC converter in the fuel cell system according to the determined current limiting adjustment parameter. Wherein, the current limiting value is directly proportional to the current limiting adjustment parameter.

According to a third aspect of the present disclosure, a controller is provided. The controller comprises at least one processor; and a memory. The memory is coupled to the at least one processor and has instructions stored thereon. The instructions, when executed by the at least one processor, cause the controller to perform the method provided according to the first aspect of the present disclosure.

According to a fourth aspect of the present disclosure, a fuel cell system is provided. The fuel cell system comprises: the controller according to the third aspect of the present disclosure.

According to a fifth aspect of the present disclosure, a program product is provided, the program product being tangibly stored on a non-volatile machine-readable medium and comprising machine-executable instructions, the machine-executable instructions, when executed, causing the machine to execute the method provided according to the first aspect of the present disclosure.

According to a sixth aspect of the present disclosure, a machine-readable storage medium is provided. The machine-readable storage medium has machine-executable instructions stored thereon, wherein the machine-executable instructions are executed by a processor to implement the method provided according to the first aspect of the present disclosure.

### BRIEF DESCRIPTION OF THE DRAWINGS

The exemplary examples of the present disclosure will be described in further detail in conjunction with accompanying drawings in order to further clarify the above-mentioned and other objectives, features, and advantages of the present disclosure, wherein in the exemplary examples of the present disclosure, the same reference number typically represents the same part.

FIG. 1 shows a schematic diagram of a fuel cell system according to a plurality of examples of the present disclosure.

FIG. 2 shows a schematic diagram of an exemplary environment in which the apparatus and/or method according to examples of the present disclosure may be implemented.

FIG. 3 shows a flow chart of a method for limiting current according to examples of the present disclosure.

FIG. 4 shows an exemplary process for monitoring the power of a hydrogen circulating pump in a low stack power scenario according to examples of the present disclosure.

FIG. 5 shows an exemplary process for monitoring the power of a hydrogen circulating pump in a high stack power scenario according to examples of the present disclosure.

FIG. 6 shows an exemplary schematic diagram of a method for limiting current according to examples of the present disclosure.

FIG. 7 shows a schematic block diagram of an apparatus for limiting current according to examples of the present disclosure.

FIG. 8 shows a schematic block diagram of a controller suitable for implementing the examples of the present disclosure.

In the various accompanying drawings, the same or corresponding numbers represent the same or corresponding portions. It is to be noted that the elements in the figures are schematic and not to scale.

### DETAILED DESCRIPTION

The examples of the present disclosure will be described in further detail below with reference to the accompanying drawings. While certain examples of the present disclosure are shown in the accompanying drawings, it should be understood that the present disclosure may be implemented in various forms and should not be construed as being limited to the examples set forth herein, rather these examples are provided for a more thorough and complete understanding of the present disclosure. It should be understood that the accompanying drawings and examples of the present disclosure are for exemplary purposes only and are not intended to limit the scope of protection of the present disclosure.

In the description of the examples of the present disclosure, the term “comprise” and other similar expressions should be understood as open-ended inclusion, that is, “comprising but not limited to.” The term “based on” should be understood as “at least partially based on.” The term “one example” or “this example” should be understood as “at least one example.” The terms “first,” “second,” etc. may refer to different objects or the same object. The text below may comprise other specific and implicit meanings.

Unless defined otherwise, all terms used herein (including technical and scientific terms) have the same meaning as commonly understood by those skilled in the art to whom the present subject matter is directed. It will further be understood that terms such as those defined in commonly-used dictionaries should be construed as having meanings consistent with their meaning in the context of the specification and relevant techniques and will not be construed in an idealized or overly formal form unless otherwise expressly defined herein. As used herein, a representation that two or more portions are “connected” or “coupled” together shall refer to the incorporation of those portions directly together or through at least one intermediate component.

As previously noted, FCEVs use fuel cell systems as their primary power source. Fuel cell systems may also be referred to as fuel cell power modules (FCPMs). A shortage of hydrogen may occur during the operation of a fuel cell system. This situation should be avoided during the control of a fuel cell system. Insufficient hydrogen may lead to irreversible loss of catalytic activity and damage to the stack. The main causes of insufficient hydrogen are insufficient hydrogen supply at the anode inlet of the stack and stack flooding. The reason for the flooding of the stack is that too much liquid in the stack blocks the flow of hydrogen gas in the cell.

To avoid insufficient hydrogen, examples of the present disclosure propose a method for limiting current. The method proposes considering the risk of stack flooding when limiting the maximum extraction value of the stack current. This is because the higher the current in the stack, the more water is produced during the electrochemical reaction, and therefore the higher the risk of insufficient hydrogen due to stack flooding. The method proposes to judge whether the fuel cell system has experienced stack flooding by utilizing the power of the hydrogen circulating pump and to adjust the maximum extraction value based on the power of the hydrogen circulating pump. The setting of the maximum extraction value described above takes into account the risk of stack flooding, thus avoiding excessive stack current that could lead to stack flooding and insufficient hydrogen. In this way, the method proposed in the examples of the present disclosure is more conducive to the operation of a fuel cell system.

FIG. 1 shows a schematic diagram of a fuel cell system 100 according to a plurality of examples of the present disclosure. As shown in FIG. 1, the fuel cell system 100 may comprise a fuel cell stack 101. The fuel cell stack 101 may comprise a cathode 102, an anode 103, and a membrane electrode 104. Oxygen in the cathode 102 and hydrogen in the anode 103 may undergo an electrochemical reaction on the membrane electrode 104, generating electrical energy. The fuel cell system 100 may further comprise a DC-DC converter 120. The DC-DC converter 120 may regulate the voltage and current output by the fuel cell stack 101 and convert the changing voltage provided by the fuel cell stack 101 into a stable output voltage. It should be understood that the fuel cell stack 101 in FIG. 1 is merely a schematic diagram for illustration purposes. In some examples, the fuel cell stack 101 may comprise multiple single cells connected in series, and each single cell may comprise a cathode, an anode, and a membrane electrode.

The fuel cell system 100 may further comprise a hydrogen injector 105, a water separator 106, a hydrogen circulating pump 107, a drain valve 108, and a hydrogen purge valve 109. The hydrogen injector 105 may supply hydrogen from the hydrogen storage system to the anode 103 and control the pressure and flow rate of the hydrogen. The water separator 106 may separate liquid water from gas at the outlet of the anode 103 and drain the liquid water through the drain valve 108. The hydrogen purge valve 109, also referred to as a purge valve, may discharge impurity gases (e.g., nitrogen) from the anode 103 when the concentration of impurity gases increases. The hydrogen circulating pump 107 may recirculate unreacted hydrogen from the outlet of the anode 103 back to the inlet of the anode 103.

The fuel cell system 100 may further comprise a filter 110, an electronic air compressor (EAC) 111, an intercooler 112, an upstream shut-off valve 113, an exhaust throttle valve 114, a bypass valve 115, an exhaust muffler 116, and a hydrogen sensor 117. The filter 110 may be referred to as an air filter and may filter particulate impurities in the air to avoid any blockage of the pipes of the fuel cell system 100. The electronic air compressor 111 may pressurize air to supply the cathode 102 of the fuel cell stack 101 with air. The intercooler 112 may cool the compressed air provided by the electronic air compressor 111. The upstream shut-off valve 113 remains open during operation of the fuel cell system 100 and closes when the fuel cell system 100 is shut down. The exhaust throttle valve 114 may discharge the reacted cathode gas, adjust the gas pressure at the cathode 102 outlet, and regulate the flow rate of gas supplied to the fuel cell stack 101. The bypass valve 115 may open when the upstream shut-off valve 113 is closed to discharge air supplied by the electronic air compressor 111. The exhaust muffler 116 may reduce the noise of the fuel cell system 100 during exhaust. The hydrogen sensor 117 may detect the concentration of hydrogen in the exhaust of the fuel cell system.

The fuel cell system 100 may further comprise a fuel cell control unit (FCCU) 130. The FCCU 130 may receive signals from the components in the fuel cell system 100 or send signals to the components to control the components to achieve overall control of the fuel cell system. In some examples, the FCCU 130 may communicate with the components in the fuel cell system 100 via wired or wireless communication methods (including but not limited to controller area network (CAN) bus, local interconnect network (LIN) bus, media oriented systems transport (MOST) bus, vehicle Ethernet, Wi-Fi, Bluetooth, etc.).

It should be understood that the fuel cell system 100 shown in FIG. 1 is merely a demonstration of the examples of the present disclosure and should not be construed as a limitation on the examples of the present disclosure. For example, in some examples, the fuel cell system 100 may further comprise more or fewer components, such as pressure sensors for detecting pressure and temperature sensors for detecting temperature. In the examples of the present disclosure, the names of the components in the fuel cell system 100 are merely illustrative, and in some examples, components having the same or similar functions may have different names. In some examples, the components in the fuel cell system 100 may be replaced, and the components before and after replacement may achieve the same or similar functions. It should be understood that the solution provided in the examples of the present disclosure may also be applied to other types of fuel cell systems. The fuel cell system in the examples of the present disclosure may be applied to various scenarios and can be configured as a power source or auxiliary power in various devices, including but not limited to vehicles, yachts, aerospace equipment, underwater power equipment, etc.

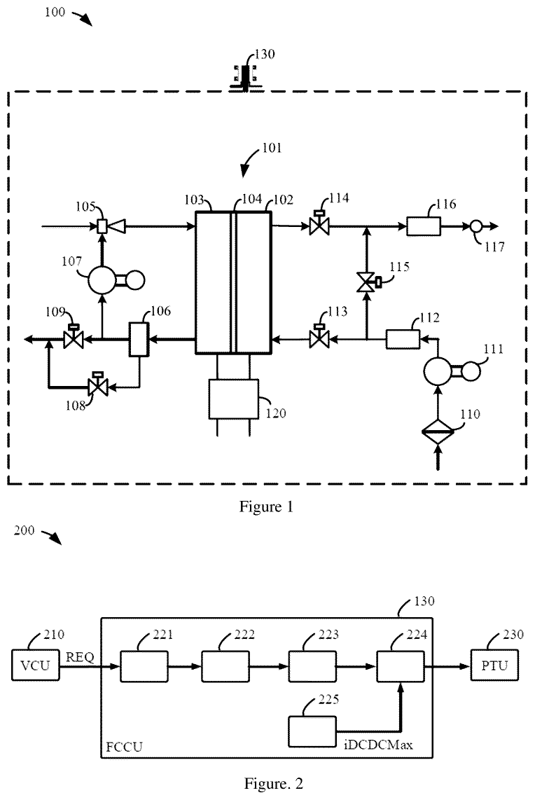

FIG. 2 shows a schematic diagram of an exemplary environment 200 in which the apparatus and/or method according to examples of the present disclosure may be implemented. The exemplary environment 200 may comprise a portion of the fuel cell system 100 shown in FIG. 1. In the exemplary environment 200, the vehicle control unit (VCU) 210 in the FCEV sends a power request REQ to the FCCU 130. The power request REQ indicates the power that the fuel cell system 100 should provide to the FCEV. The FCCU 130 may smooth the power requested by the VCU 210 with a ramp function to avoid a step response from the fuel cell system 100 at block 221. The FCCU 130 may conduct low-pass filtering to filter out the noise in the power request at block 222. The FCCU 130 may determine the current of the DC-DC converter 120 based on the requested power and the polarization curve characteristics of the stack at block 223. The FCCU 130 may determine the current request setting to be sent to the power transmission unit (PTU) 230 based on the maximum extraction value of the stack current iDCDCMax at block 224. The maximum extraction value of the stack current, iDCDCMax, is determined at block 225 according to the method for limiting current proposed in the present disclosure. At block 224, if the current value determined at block 223 is greater than iDCDCMax, then the current request setting is limited to iDCDCMax. If the current value determined at block 223 is less than or equal to iDCDCMax, then the current request setting is equal to the current value determined at block 223. The PTU 230 controls the DC-DC converter 120 to perform a boost operation based on the current request setting.

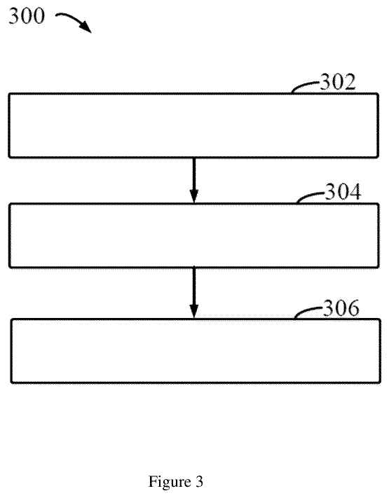

FIG. 3 shows a flow chart of a method 300 for limiting current according to examples of the present disclosure. The method 300 may be performed by an apparatus for limiting current. The apparatus may be implemented through software and/or hardware, e.g., it may be a controller. The controller may, for example, be the FCCU in a fuel cell system. The method 300 is schematically described below by taking a controller as the execution entity. Referring to FIG. 3, the method 300 may comprise blocks 302 to 306.

In block 302, the controller determines the power of the hydrogen circulating pump in the fuel cell system. The power of the hydrogen circulating pump may be used to indicate the risk of stack flooding. In some examples of the present disclosure, the power of the hydrogen circulating pump may be determined in real time. In other examples of the present disclosure, the power of the hydrogen circulating pump may be determined in non-real time.

In block 304, the controller determines the current limiting adjustment parameter based on the power of the hydrogen circulating pump. Wherein, the current limiting adjustment parameter is inversely proportional to the power of the hydrogen circulating pump. The higher the power of the hydrogen circulating pump, the greater the risk of stack flooding, meaning that the current limiting adjustment parameter must be reduced. The lower the power of the hydrogen circulating pump, the lower the risk of stack flooding, meaning that the current limiting adjustment parameter may be increased.

In block 306, the controller adjusts the current limiting value of the DC-DC converter in the fuel cell system according to the determined current limiting adjustment parameter. Wherein, the current limiting value is directly proportional to the current limiting adjustment parameter. The higher the current limiting adjustment parameter, the greater the current limiting value may be. The lower the current limiting adjustment parameter, the lower the current limiting value must be.

The method 300 for limiting current according to examples of the present disclosure takes into account that insufficient hydrogen may occur due to stack flooding in the fuel cell system when setting the current limiting value of the DC-DC converter. The method 300 uses the power of the hydrogen circulating pump to judge whether the fuel cell system is flooded, thereby adjusting the current limiting value of the DC-DC converter to maintain the normal operation of the fuel cell system when hydrogen is insufficient.

In some examples of the present disclosure, the controller obtains a drive current, a supply voltage, and a reference value of the supply voltage of the hydrogen circulating pump. The controller then determines the power of the hydrogen circulating pump based on the obtained drive current, supply voltage, and reference value of the supply voltage. The manner in which the power of the hydrogen circulating pump is determined may differ between low stack power and high stack power scenarios. A low stack power scenario is a scenario where the stack power of the fuel cell system is lower than a first power threshold. A high stack power scenario is a scenario where the stack power of the fuel cell system is higher than a first power threshold. The stack power of a fuel cell system may be determined by the product of the stack voltage and the stack current of the fuel cell system. The first power threshold may be an empirical value.

FIG. 4 shows an exemplary process for monitoring the power of a hydrogen circulating pump in a low stack power scenario according to examples of the present disclosure. In the example of FIG. 4, the controller obtains the drive current I_drv, the supply voltage V1, and the reference value V1_ref of the supply voltage of the hydrogen circulating pump. The drive current I_drv and the supply voltage V1 of the hydrogen circulating pump may be obtained by real-time measurement. The reference value V1_ref of the supply voltage may be determined according to the specifications of the specific hydrogen circulating pump.

At block 402, the controller divides the supply voltage V1 of the hydrogen circulating pump by the reference value V1_ref of the supply voltage to obtain the quotient of the two. At block 404, the controller multiplies the drive current I_drv of the hydrogen circulating pump by the quotient obtained at block 402 to obtain the target current I_tar. At block 406, the controller multiplies the target current I_tar by the voltage coefficient VolPar to obtain their product Pow and determines their Pow as the power of the hydrogen circulating pump. The voltage coefficient VolPar may be a predetermined constant.

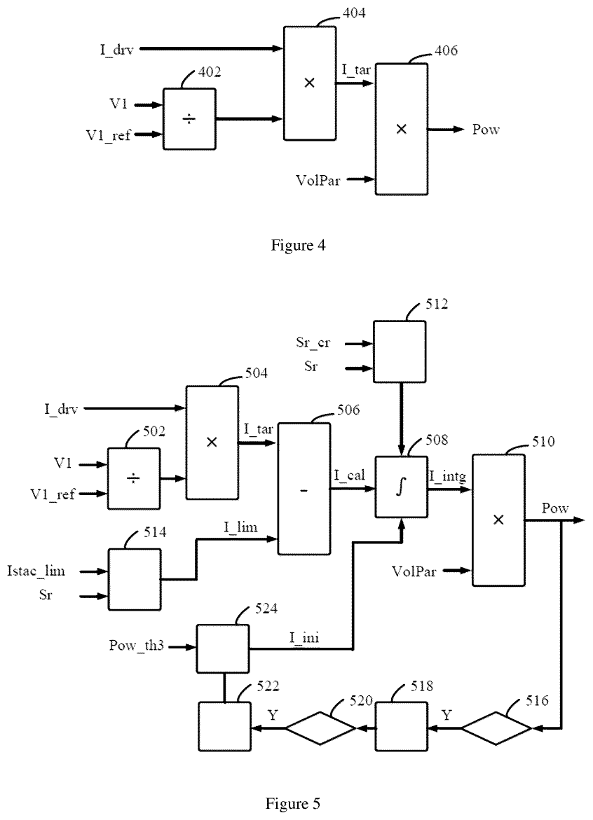

FIG. 5 shows an exemplary process for monitoring the power of a hydrogen circulating pump in a high stack power scenario according to examples of the present disclosure. At block 502, the controller divides the supply voltage V1 of the hydrogen circulating pump by the reference value V1_ref of the supply voltage to obtain the quotient of the two. At block 504, the controller multiplies the drive current I_drv of the hydrogen circulating pump by the quotient obtained at block 502 to obtain the target current I_tar.

At block 514, the controller determines the current limit I_lim of the hydrogen circulating pump based on the stack current Isac_lim of the fuel cell system and the rotational speed Sr of the hydrogen circulating pump. The rotational speed Sr is the rotational speed of the fan impeller of the hydrogen circulating pump. In some examples of the present disclosure, the stack current Isac_lim and the rotational speed Sr of the hydrogen circulating pump may be obtained by real-time measurement. The current limit I_lim corresponding to the stack current Isac_lim and the rotational speed Sr may be found in the preset current limit mapping table. The current limit mapping table is a mapping table comprising three dimensions: the stack current Istac_lim, the rotational speed Sr, and the current limit I_lim. Given the stack current Istac_lim and the rotational speed Sr, the corresponding current limit I_lim may be retrieved from the mapping table.

At block 506, the controller subtracts the current limit I_lim of the hydrogen circulating pump from the target current I_tar to obtain the calibration current I_cal of the hydrogen circulating pump. In a high stack power scenario, the current of the hydrogen circulating pump may oscillate at a high frequency. The current of the hydrogen circulating pump can therefore be calibrated here by calibrating the current I_cal.

At block 508, the controller integrates the calibration current I_cal to obtain a cumulative current I_intg. In some examples of the present disclosure, in the process of integrating the calibration current I_cal to obtain the cumulative current, currents with negative values can be filtered out from the calibration current I_cal to obtain a filtered calibration current. The filtered calibration current is then integrated to obtain the cumulative current. In one example, the calibration current I_cal may be compared with the value “0,” and the larger of the calibration current I_cal and the value “0” is selected to perform the subsequent integration process. This ensures that only the portion of the hydrogen circulating pump current exceeding the current limit I_lim can participate in the subsequent integration process.

In some examples of the present disclosure, before performing the integration operation based on the calibration current I_cal, an integration enable condition may be set and the integration operation may be enabled only when the enable condition is met. For example, the controller may determine at block 512 whether the rotational speed Sr of the hydrogen circulating pump is within a predetermined range and whether the rate of change of the rotational speed Sr_cr is lower than a rate of change threshold. If the rotational speed Sr of the hydrogen circulating pump is determined to be within the predetermined range and the rate of change of the rotational speed Sr_cr is lower than the rate of change threshold, the controller integrates the calibration current I_cal to obtain the cumulative current I_intg. The inventors of the present disclosure note that during the switching phase of the operating point of the hydrogen circulating pump, current oscillations are caused. However, this oscillation is not caused by excessive water or inert gas at the anode of the hydrogen circulating pump. Therefore, this oscillation needs to be ruled out when judging the risk of stack flooding based on the power of the hydrogen circulating pump. If the rotational speed Sr of the hydrogen circulating pump is not within the predetermined range, or if the rate of change of the rotational speed Sr_cr of the hydrogen circulating pump is higher than the rate of change threshold, this indicates that the operating point of the hydrogen circulating pump is switching. By determining that the rotational speed Sr of the hydrogen circulating pump is within the predetermined range and that the rate of change of the rotational speed Sr_cr of the hydrogen circulating pump is lower than the rate of change threshold, the normal switching of the operating point of the hydrogen circulating pump can be ruled out when determining whether stack flooding has occurred.

At block 510, the controller determines the power Pow of the hydrogen circulating pump by multiplying the cumulative current I_intg by the voltage coefficient VolPar. The voltage coefficient VolPar may be a predetermined constant. In this context, the power Pow of the hydrogen circulating pump refers to the cumulative value of the power Pow of the hydrogen circulating pump.

Some examples of the present disclosure further propose a method for setting the initial value of integration used when integrating the calibration current I_cal at block 508. For example, the controller may determine at block 516 whether the power is lower than a second power threshold. The second power threshold may be an empirical value. If the controller determines that the power is lower than the second power threshold (“Y” at block 516), the controller increments the time count at block 518. The controller may determine at block 520 whether the time count has reached a count threshold. The count threshold may be an empirical value. If the controller determines that the time count has reached the count threshold (“Y” at block 520), the controller reduces the power by a predetermined calibration amount at block 522 to obtain a reduced power. The controller further resets the time count at block 522. The controller then compares the reduced power to a third power threshold Pow_th3 at block 524. In one example, the third power threshold Pow_th3 is 0. The larger of the decreased power and the third power threshold is selected as the initial value for integrated I_ini. The initial value for integration I_ini is set at block 508 as the initial value for integrating the calibration current. This avoids the accumulation of small values into large values over a long period of integration, which would lead to inaccurate determination of the power Pow of the hydrogen circulating pump at block 510.

In some examples of the present disclosure, the controller may determine the current limiting reference value based on candidates. The controller then takes the product of the current limiting reference value and the determined current limiting adjustment parameter as the current limiting value of the DC-DC converter. The candidates may be the reduction in the upstream pressure of the hydrogen injector in the fuel cell system, the temperature of the stack inlet coolant in the fuel cell system, or the air supply in the fuel cell system; or a combination of two or three of the above. The candidates may further comprise other parameters in the fuel cell system.

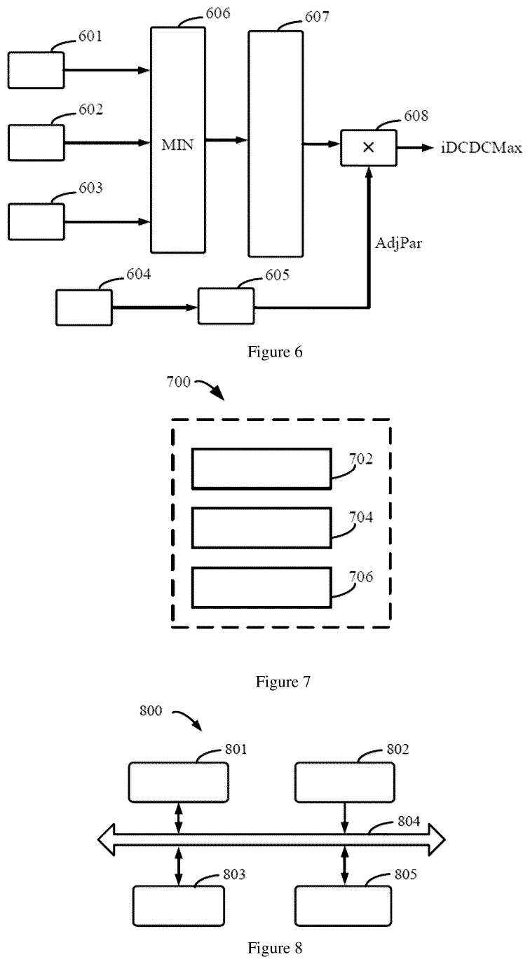

FIG. 6 shows an exemplary schematic diagram of a method for limiting current according to examples of the present disclosure. In the example of FIG. 6, the candidates comprise the reduction in the upstream pressure of the hydrogen injector in the fuel cell system 601, the temperature of the stack inlet coolant in the fuel cell system 602, and the air supply in the fuel cell system 603.

At block 606, the controller determines a minimum current limiting value based on the candidates. In some examples of the present disclosure, at block 606, the controller determines the influence factor of each of the candidates on the current limiting reference value. The controller determines the minimum factor value among the influence factors. The controller then determines the minimum current limiting value based on the minimum factor value. The reduction in the upstream pressure of the hydrogen injector is directly proportional to its corresponding influence factor, the temperature of the stack inlet coolant is directly proportional to its corresponding influence factor, and the air supply is inversely proportional to its corresponding influence factor.

At block 607, the controller smoothly transitions the present current limiting reference value to the minimum current limiting value. In some examples of the present disclosure, the controller may use a ramp function to smooth the present current limiting reference value. When the present current limiting reference value is lower than the minimum current limiting value, the controller causes the current limiting reference value to slowly rise to the minimum current limiting value. This prevents a step response from occurring in the fuel cell system.

At block 604, the controller obtains the power of the hydrogen circulating pump according to the process shown in FIG. 4 or FIG. 5. In block 605, the controller determines the current limiting adjustment parameter AdjPar based on the power of the hydrogen circulating pump. In some examples of the present disclosure, the controller may store a mapping table of the power of the hydrogen circulating pump and the current limiting adjustment parameter AdjPar. The mapping table may be obtained based on empirical values. In this mapping table, the power of the hydrogen circulating pump is inversely proportional to the current limiting adjustment parameter AdjPar. The higher the power of the hydrogen circulating pump, the smaller the current limiting adjustment parameter AdjPar. The lower the power of the hydrogen circulating pump, the larger the current limiting adjustment parameter AdjPar. In one example, the inverse relationship between the power of the hydrogen circulating pump and the current limiting adjustment parameter AdjPar is non-linear.

At block 608, the controller multiplies the current limiting value output at block 607 by the current limiting adjustment parameter AdjPar to obtain the maximum extraction value of the stack current, iDCDCMax (i.e., the current limiting value of the DC-DC converter).

FIG. 7 shows a block diagram of an apparatus 700 for processing signals according to some examples of the present disclosure. As shown in FIG. 7, the apparatus 700 comprises a first determination unit 702, a second determination unit 704, and an adjustment unit 706. The first determination unit 702 is configured to determine the power of a hydrogen circulating pump in a fuel cell system. The second determination unit 704 is configured to determine a current limiting adjustment parameter based on the power of the hydrogen circulating pump. Wherein, the current limiting adjustment parameter is inversely proportional to the power of the hydrogen circulating pump. The adjustment unit 706 is configured to adjust a current limiting value of a DC-DC converter in the fuel cell system according to the determined current limiting adjustment parameter. Wherein, the current limiting value is directly proportional to the current limiting adjustment parameter.

In some examples of the present disclosure, the apparatus 700 further comprises a third determination unit. The third determination unit is configured to determine the current limiting reference value based on candidates. The candidates comprise at least one of the following in the fuel cell system: the reduction in the upstream pressure of the hydrogen injector, the temperature of the stack inlet coolant, or the air supply. The adjustment unit 706 is configured to use the product of the current limiting reference value and the current limiting adjustment parameter as the current limiting value of the DC-DC converter.

In some examples of the present disclosure, the third determination unit comprises a fourth determination unit and a smoothing unit. The fourth determination unit is configured to determine the minimum current limiting value based on candidates. The smoothing unit is configured to smoothly transition the present current limiting reference value to the minimum current limiting value.

In some examples of the present disclosure, the fourth determination unit comprises a fifth determination unit, a sixth determination unit, and a seventh determination unit. The fifth determination unit is configured to determine the influence factor of each candidate on the current limiting reference value. The sixth determination unit is configured to determine the minimum factor value among the influence factors. The seventh determination unit is configured to determine the minimum current limiting value based on the minimum factor value. When the candidates comprise the reduction in the upstream pressure of the hydrogen injector, the reduction in the upstream pressure of the hydrogen injector is proportional to its corresponding influence factor. When the candidates comprise the temperature of the stack inlet coolant, the temperature of the stack inlet coolant is proportional to its corresponding influence factor. When the candidates comprise the air supply, the air supply is inversely proportional to its corresponding influence factor.

In some examples of the present disclosure, the first determination unit 702 comprises a first obtaining unit and an eighth determination unit. The first obtaining unit is configured to obtain the drive current, the supply voltage, and the reference value of the supply voltage of the hydrogen circulating pump. The eighth determination unit is configured to determine the power of the hydrogen circulating pump based on the drive current, the supply voltage, and the reference value.

In some examples of the present disclosure, the eighth determination unit comprises a multiplication unit, a ninth determination unit, and a tenth determination unit. The multiplication unit is configured to multiply the quotient of the supply voltage and the reference value by the drive current to obtain a target current. The ninth determination unit is configured to determine if the stack power of the fuel cell system is lower than a first power threshold. The tenth determination unit is configured to determine the power of the hydrogen circulating pump by multiplying the target current and the voltage coefficient in response to determining that the stack power is lower than the first power threshold.

In some examples of the present disclosure, the eighth determination unit further comprises: a second obtaining unit, a subtraction unit, an integration unit, and an eleventh determination unit. The second obtaining unit is configured to obtain a current limit of the hydrogen circulating pump in response to determining that the stack power is higher than or equal to the first power threshold. The subtraction unit is configured to subtract the current limit from the target current to obtain the calibration current of the hydrogen circulating pump. The integration unit is configured to integrate the calibration current to obtain a cumulative current. The eleventh determination unit is configured to determine the power of the hydrogen circulating pump by the product of the cumulative current and the voltage coefficient.

In some examples of the present disclosure, the second obtaining unit comprises a third obtaining unit, a fourth obtaining unit, and a twelfth determination unit. The third obtaining unit is configured to obtain the stack current of the fuel cell system. The fourth obtaining unit is configured to obtain the rotational speed of the hydrogen circulating pump. The twelfth determination unit is configured to determine the current limit of the hydrogen circulating pump based on the stack current and the rotational speed.

In some examples of the present disclosure, the integration unit comprises a filtering unit and an integration sub-unit. The filtering unit is configured to filter out currents with negative values from the calibration current to obtain a filtered calibration current. The integration sub-unit is configured to integrate the filtered calibration current to obtain a cumulative current.

In some examples of the present disclosure, the integration unit further comprises a thirteenth determination unit and a fourteenth determination unit. The thirteenth determination unit is configured to determine whether the rotational speed of the hydrogen circulating pump is within a predetermined range. The fourteenth determination unit is configured to determine whether the rate of change of the rotational speed is lower than a rate of change threshold. The integration sub-unit is configured to integrate the calibration current to obtain the cumulative current in response to determining that the rotational speed is within a predetermined range and the rate of change of the rotational speed is lower than the rate of change threshold.

In some examples of the present disclosure, the integration sub-unit comprises a fifteenth determination unit, a timing unit, a sixteenth determination unit, a reduction unit, a comparison unit, a selection unit, and an integration execution unit. The fifteenth determination unit is configured to determine whether the power of the hydrogen circulating pump is lower than a second power threshold. The timing unit is configured to increment the time count in response to determining that the power is lower than the second power threshold. The sixteenth determination unit is configured to determine whether the time count has reached a count threshold. The reduction unit is configured to reduce the power by a predetermined calibration amount in response to a determination that the time count has reached the count threshold in order to obtain a reduced power. The comparison unit is configured to compare the reduced power with a third power threshold. The selection unit is configured to select the larger of the reduced power and the third power threshold as the initial value for integration. The integration execution unit is configured to integrate the calibration current using the initial value for integration to obtain the cumulative current.

FIG. 8 shows a schematic block diagram of a controller 800 that may be used to implement the examples of the present disclosure. For example, the FCCU 130 of FIG. 1 may be implemented using the controller 800. As shown in FIG. 8, the controller 800 comprises a processor 801, which can perform various appropriate actions and processes according to computer program instructions stored in a read-only memory (ROM) 802 and loaded into a random-access memory (RAM) 803. Various programs and data required for the operation of the controller 800 may also be stored in the RAM 803. The processor 801, the ROM 802, and the RAM 803 are interconnected via a bus 804. An input/output (I/O) interface 805 is also connected to the bus 804.

The various processes and processing described above, such as the method 300, may be executed by the processor 801. For example, in some examples, the method 300 can be implemented as a software program tangibly contained in a machine-readable medium. In some examples, part or all of the software programs may be loaded and/or installed onto the controller 800 through the ROM 802. When the software program is loaded onto the RAM 803 and executed by the processor 801, one or more actions of the method 300 described above may be performed.

In summary, the method for limiting current according to examples of the present disclosure takes into account that insufficient hydrogen may occur due to stack flooding in the fuel cell system when setting the current limiting value of the DC-DC converter. The method uses the power of the hydrogen circulating pump to judge whether the fuel cell system is flooded, thereby adjusting the current limiting value of the DC-DC converter to maintain the normal operation of the fuel cell system when hydrogen is insufficient.

The functions described above herein may be performed at least partially by one or more hardware logic components. For example, and without limitation, exemplary types of hardware logic components that can be used comprise: Field Programmable Gate Arrays (FPGA), Application Specific Integrated Circuits (ASIC), Application Specific Standard Products (ASSP), System on a Chip (SOC), Complex Programmable Logic Devices (CPLD), and the like.

The program code used to implement the method of the present disclosure may be written using any combination of one or more programming languages. This program code can be provided to a processor or controller of a general-purpose computer, special-purpose computer or other programmable data processing devices such that the program code, when executed by the processor or controller, causes the functions/operations specified in the flowcharts and/or block diagrams to be implemented. The program code can be executed entirely on the machine, partly on the machine, as a stand-alone software package partly on the machine and partly on a remote machine, or entirely on a remote machine or server.

In the context of the present disclosure, a machine-readable medium can be a tangible medium that can contain or store programs for use by or in conjunction with an instruction execution system, apparatus, or device. The machine-readable medium can be a machine-readable signal medium or a machine-readable storage medium. The machine-readable medium can comprise, but is not limited to, electronic, magnetic, optical, electromagnetic, infrared, or semiconductor systems, apparatuses, or devices, or any suitable combination of the foregoing. More specific examples of the machine-readable storage medium would comprise electrical connections based on one or more wires, portable computer disks, hard disks, random access memory (RAM), read-only memory (ROM), erasable programmable read-only memory (EPROM or flash memory), optical fibers, portable compact disc read-only memory (CD-ROM), optical storage devices, magnetic storage devices, or any suitable combination of the foregoing. Furthermore, although operations have been depicted in a specific order, it should be understood that such operations are not required to be performed in the specific order shown or in sequential order, nor are all illustrated operations required to be performed to achieve the desired results. In certain contexts, multitasking and parallel processing may be advantageous. Similarly, although several specific implementation details are included in the above discussion, these should not be construed as limiting the scope of the present disclosure. Some features described in the context of separate examples may also be implemented in a single implementation in combination. Conversely, various features described in the context of a single implementation can also be implemented separately or in any suitable sub-combination in multiple implementations.

Although the present subject matter has been described in languages that are specific to structural features and/or method logical actions, it should be understood that the subject matter defined in the appended claims is not necessarily limited to the particular features or actions described above. Rather, the specific features and operations described above are merely exemplary forms of implementing the claims.

The singular forms of the terms used herein and in the appended claims include the plural, and vice versa, unless the context clearly dictates otherwise. As such, when referring to the singular, it is common to include the plural of the respective terms. Where the term “example” is used herein, particularly when it follows a set of terms, the “example” is merely exemplary and illustrative and should not be considered exclusive or broad.

Further aspects and areas of applicability will become apparent from the description provided herein. It will be understood that various aspects of the present application may be implemented alone or in combination with at least one other aspect. It will also be understood that the description and specific examples herein are intended to be illustrative only and are not intended to limit the scope of the present application.

The various examples of the present disclosure have been described above. The descriptions provided are exemplary and not exhaustive, and they are also not limited to the disclosed examples. Many modifications and variations will be apparent to those skilled in the art without departing from the scope and spirit of the described examples. The selection of terms used in this text aims to best explain the principles and actual application of the various examples or the technological improvements in the market or to allow others skilled in the art to understand the various examples disclosed in this text.

What is claimed is:

1. A method for limiting current, comprising:
determining power of a hydrogen circulating pump in a fuel cell system;
determining a current limiting adjustment parameter based on the power of the hydrogen circulating pump, wherein the current limiting adjustment parameter is inversely proportional to the power of the hydrogen circulating pump; and
adjusting a current limiting value of a DC-DC converter in the fuel cell system according to the determined current limiting adjustment parameter, wherein the current limiting value is directly proportional to the current limiting adjustment parameter.

2. The method according to claim 1, further comprising:
determining a current limiting reference value based on candidates, wherein the candidates comprise at least one of the following in the fuel cell system: the reduction in the upstream pressure of the hydrogen injector, the temperature of the stack inlet coolant, or the air supply;
wherein adjusting the current limiting value of the DC-DC converter in the fuel cell system according to the determined current limiting adjustment parameter comprises:
taking the product of the current limiting reference value and the determined current limiting adjustment parameter as the current limiting value of the DC-DC converter.

3. The method according to claim 2, wherein determining the current limiting reference value based on the candidates comprises:
determining a minimum current limiting value based on the candidates; and
smoothly transitioning the present current limiting reference value to the minimum current limiting value.

4. The method according to claim 3, wherein determining the minimum current limiting value based on the candidates comprises:
determining the influence factors of each candidate on the current limiting reference value;
determining the minimum factor value among the influence factors; and
determining the minimum current limiting value based on the minimum factor value,
wherein, when the candidates comprise the reduction in the upstream pressure of the hydrogen injector, the reduction in the upstream pressure of the hydrogen injector is proportional to its corresponding influence factor,
wherein, when the candidates comprise the temperature of the stack inlet coolant, the temperature of the stack inlet coolant is proportional to its corresponding influence factor, and
wherein, when the candidates comprise the air supply, the air supply is inversely proportional to its corresponding influence factor.

5. The method according to claim 1, wherein determining the power of the hydrogen circulating pump in the fuel cell system comprises:
obtaining a drive current, a supply voltage, and a reference value of the supply voltage of the hydrogen circulating pump; and
determining the power of the hydrogen circulating pump based on the drive current, the supply voltage, and the reference value.

6. The method according to claim 5, wherein determining the power of the hydrogen circulating pump based on the drive current, the supply voltage, and the reference value comprises:
multiplying the quotient of the supply voltage and the reference value by the drive current to obtain a target current;
determining whether the stack power of the fuel cell system is lower than a first power threshold; and
in response to determining that the stack power is lower than the first power threshold, determining the product of the target current and a voltage coefficient as the power of the hydrogen circulating pump.

7. The method according to claim 6, wherein determining the power of the hydrogen circulating pump based on the drive current, the supply voltage, and the reference value further comprises:
obtaining a current limit for the hydrogen circulating pump in response to determining that the stack power is higher than or equal to the first power threshold;
subtracting the current limit from the target current to obtain a calibration current for the hydrogen circulating pump;
integrating the calibration current to obtain a cumulative current; and
determining the product of the cumulative current and the voltage coefficient as the power of the hydrogen circulating pump.

8. The method according to claim 7, wherein obtaining the current limit of the hydrogen circulating pump comprises:
obtaining a stack current of the fuel cell system;
obtaining a rotational speed of the hydrogen circulating pump; and
determining the current limit of the hydrogen circulating pump based on the stack current and the rotational speed.

9. The method according to claim 8, wherein integrating the calibration current to obtain the cumulative current comprises:
filtering out currents with negative values from the calibration current to obtain a filtered calibration current; and
integrating the filtered calibration current to obtain the cumulative current.

10. The method according to claim 9, wherein integrating the calibration current to obtain the cumulative current further comprises:
determining whether the rotational speed of the hydrogen circulating pump is within a predetermined range;
determining whether the rate of change of the rotational speed is lower than a rate of change threshold; and
integrating the calibration current to obtain the cumulative current in response to determining that the rotational speed is within the predetermined range and that the rate of change of the rotational speed is lower than the rate of change threshold.

11. The method according to claim 7, wherein integrating the calibration current to obtain the cumulative current comprises:
determining whether the power of the hydrogen circulating pump is lower than a second power threshold;
incrementing a time count in response to determining that the power is lower than the second power threshold;
determining whether the time count has reached a count threshold;
reducing the power by a predetermined calibration amount to obtain a reduced power in response to determining that the time count has reached the count threshold;
comparing the reduced power with a third power threshold;
selecting the larger of the reduced power and the third power threshold as an initial value for integration; and
integrating the calibration current using the initial value for integration to obtain the cumulative current.

12. An apparatus for limiting current, comprising:
a first determination unit configured to determine power of a hydrogen circulating pump in a fuel cell system;
a second determination unit configured to determine a current limiting adjustment parameter based on the power of the hydrogen circulating pump, wherein the current limiting adjustment parameter is inversely proportional to the power of the hydrogen circulating pump; and
an adjustment unit configured to adjust a current limiting value of a DC-DC converter in the fuel cell system according to the determined current limiting adjustment parameter, wherein the current limiting value is directly proportional to the current limiting adjustment parameter.

13. A controller, comprising:
at least one processor, and
a memory, coupled to the at least one processor and having instructions stored thereon, wherein the instructions, when executed by the at least one processor, cause the controller to perform the method according to claim 1.

14. A fuel cell system comprising the controller according to claim 13.

15. A program product, the program product being tangibly stored on a non-volatile machine-readable medium and comprising machine-executable instructions that, when executed, cause a machine to perform the method according to claim 1.
